(19) United States
(12) Patent Application Publication
(10) Pub. No.: US 2023/0161859 A1
(43) Pub. Date: May 25, 2023

(54) CONTROL DEVICE AND CONTROL METHOD

(71) Applicant: KABUSHIKI KAISHA TOKAI RIKA DENKI SEISAKUSHO, Aichi (JP)

(72) Inventors: Takahiko ANDO, Aichi (JP); Hirokazu ITAKURA, Aichi (JP); Yohei ITO, Aichi (JP)

(73) Assignee: KABUSHIKI KAISHA TOKAI RIKA DENKI SEISAKUSHO, Aichi (JP)

(21) Appl. No.: 17/978,413

(22) Filed: Nov. 1, 2022

(30) Foreign Application Priority Data
Nov. 24, 2021 (JP) 2021-190024

(51) Int. Cl. G06F 21/34

(52) U.S. Cl. CPC G06F 21/34

(57) ABSTRACT

There are provided a control device and a control method that can reduce a time taken to perform communication between devices and authenticate a communicating party device.

A control device includes a control section configured to perform a process of deciding whether or not there is identification information that is stored in advance and matches with identification information whose authentication has previously succeeded among each identification information obtained from one or more communication devices, and a process of controlling execution of an authentication process of authenticating a communication device, according to a decision result.

### CROSS REFERENCE TO RELATED APPLICATION(S)

This application is based upon and claims benefit of priority from Japanese Patent Application No. 2021-190024, filed on Nov. 24, 2021, the entire contents of which are incorporated herein by reference.

### BACKGROUND

The present invention relates to a control device and a control method.

In recent years, a technology that performs communication between devices and authenticates a communicating party device has been developed. For example, following JP 2012-253424 A discloses a technology where an entry/exit management device performs near field wireless communication with a wireless communication terminal by using a near field wireless communication technology such as Near Field Communication (NFC), and performs personal authentication on the wireless communication terminal.

### SUMMARY

However, in a case where a plurality of communication devises are authentication process targets, an authentication process is performed on all communication devices in order, and therefore a time has been taken until authentication succeeds in some cases.

Accordingly, the present invention has been made in view of the aforementioned issue, and an object of the present invention is to provide a new and improved control device and control method that can reduce a time taken to perform communication between devices and authenticate a communicating party device.

In order to solve the above issue, a certain aspect of the present invention provides a control device including a control section configured to perform a process of deciding whether or not there is identification information that is stored in advance and matches with identification information whose authentication has previously succeeded among each identification information obtained from one or more communication devices, and a process of controlling execution of an authentication process of authenticating a communication device, according to a decision result.

Furthermore, in order to solve the above issue, another aspect of the present invention provides a control method including at a processor: deciding whether or not there is identification information that is stored in advance and matches with identification information whose authentication has previously succeeded among each identification information obtained from one or more communication devices; and controlling execution of an authentication process of authenticating a communication device, according to a decision result.

As described above, the present invention can reduce a time taken to perform communication between devices and authenticate a communicating party device.

### BRIEF DESCRIPTION OF THE DRAWINGS

FIG. 1 is an explanatory view for explaining each component of a control system according to an embodiment of the present invention.

FIG. 2 is a sequence diagram illustrating an operation example of the control system according to the embodiment.

### DETAILED DESCRIPTION OF THE EMBODIMENT(S)

A preferred embodiment of the present invention will be described in detail below with reference to the accompanying drawings. Note that components having substantially same functional configurations will be assigned the same reference numerals in the description and the drawings, and overlapping description thereof will be omitted.

Furthermore, in the description and the drawings, a plurality of components having substantially same functional configurations will be distinguished by assigning different alphabets or numbers to tails of the same reference numerals in some case. In this regard, in a case where each of the plurality of components having the substantially same functional configurations do not need to be distinguished in particular, each of a plurality of components will be assigned only the same reference numerals.

### 1. Outline

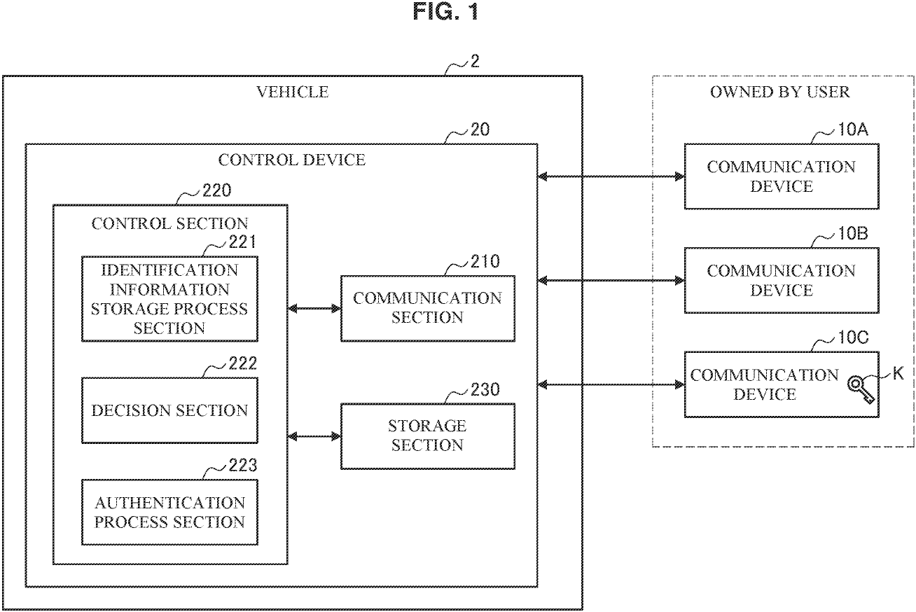

FIG. 1 is an explanatory view for explaining each component of a control system according to an embodiment of the present invention. As illustrated in FIG. 1, the control system according to the present embodiment includes a control device 20 that is mounted on a vehicle 2 that is an example of a movable body, and one or more communication devices 10 (10A to 10C) that are owned by a user and can establish communication connection with the control device 20 by wireless communication. According to the present embodiment, for example, the communication device 10C among the communication devices 10A to 10C illustrated in FIG. 1 is used to unlock a door lock of the vehicle 2.

The control device 20 has an authentication function of establishing communication connection with the communication device 10 by wireless communication, and performing an authentication process of authenticating the communication device 10. The control device 20 is mounted on or placed in the vehicle 2. A place at which the control device 20 is located in the vehicle 2 is not limited in particular.

The communication device 10 has a wireless communication function that can transmit and receive data by wireless communication with another device. Furthermore, the present embodiment assumes that, for example, the communication device 10C has authentication information that is necessary for the above authentication process. The authentication information may be, for example, an encryption key including information that indicates an algorithm used to encrypt or decrypt predetermined information. In this description, the encryption key used for the authentication process will be referred to as an authentication key. As illustrated in FIG. 1, for example, the communication device 10C includes an authentication key K. Note that the authentication key may be a common key in a case where a common key cryptography is used, or may be a private key in a case where the common key cryptography is used.

The user can unlock the door lock of the vehicle 2 by using the communication device 10C. The communication device 10C may be, for example, a smartphone. When the user places the smartphone close to the vehicle 2, the control device 20 in the vehicle 2 establishes communication connection with the smartphone by wireless communication, and executes an authentication process of authenticating the smartphone. When succeeding in authenticating the smartphone, the control device 20 performs control to unlock the door lock of the vehicle 2.

### Summary of Issue

However, there is a case where the user uses a smartphone case that houses the smartphone, and places the smartphone close to the vehicle to unlock the door lock in a state where various communication devices such as a transportation Integrated Circuit (IC) card or a payment IC card are housed in the smartphone case. In this case, the control device provided in the vehicle communicates with all communication devices, and a plurality of communication devices become authentication process targets. In addition to a case where the smartphone case is used, the various communication devices that are housed in a pocket, a bag, and a staff identity card of the user hang from a neck are also likely to communicate with the control device. There is a problem that the control device has difficulty in identifying a communication device that has authentication information that is a necessary authentication key to unlock the door lock of the vehicle among a plurality of communication devices with which communication connection has been established, and therefore perform an authentication process on all communication devices in order, and a time is taken until authentication succeeds.

The control device 20 according to the embodiment of the present invention has been conceived focusing on the above point, and makes it possible to reduce a time taken to perform communication between devices and authenticate a communicating party device. More specifically, the control device 20 controls execution of an authentication process of a communication device by using identification information for identifying a communication device whose authentication has previously succeeded.

Each component included in this control system according to the present embodiment will be described in detail below.

### 2. Configuration Example

### 2-1. Communication Device 10

The communication device 10 is owned by the user, and has a communication function of communicating with other devices. Furthermore, the communication device 10 has unique identification information. The communication device 10 may be, for example, a smartphone or an IC card. According to the present embodiment, for example, the example illustrated in FIG. 1 assumes a case where the communication device 10A is a transportation IC card, the communication device 10B is a payment IC card, and the communication device 10C is a smartphone that can unlock the door lock of the vehicle 2, that is, that includes the authentication key K that is necessary for the authentication process performed together with the control device 20.

The unique identification information described herein is information that makes it possible to uniquely identify each of the communication devices 10. An unique identification number may be, for example, a combination of numbers or symbols, or may be another example. Furthermore, the above unique identification number may be, for example, a manufacturing number that is uniquely assigned at a time of manufacturing of the communication device 10.

The communication device 10 has a communication function of performing communication that conforms to predetermined wireless communication standards with the control device 20. This communication function may be realized by a communication device that transmits and receives data to and from another device in a short communication distance. The short communication distance may be, for example, approximately 5 cm, 10 cm, 1 m or 10 m or less. According to the present embodiment, NFC whose communication distance is approximately 10 cm is used as an example of a communication system of wireless communication performed between the communication device 10 and the control device 20. However, other frequency bands or other wireless communication standards may be naturally used.

Furthermore, the authentication key K of the communication device 10C may be stored in a storage section included in the communication device 10C. Alternatively, the communication device 10C may obtain the authentication key K held in an external storage device or a server configured to be able to communicate with the communication device 10C.

The communication device 10 has been described above. Note that the communication device 10C may be realized by the smartphone, or may be realized by an IC card or a card type small device. Furthermore, the communication device 10C may be realized by various devices such as a tablet terminal and a wearable device.

### 2-2. Control Device 20

Next, a configuration of the control device 20 according to the present embodiment will be described. As illustrated in FIG. 1, the control device 20 according to the present embodiment includes a communication section 210, a control section 220, and a storage section 230.

### Communication Section 210

The communication section 210 has a function of transmitting and receiving data to and from other devices. For example, the communication section 210 according to the present embodiment establishes communication connection with each communication device 10, and obtains identification information of each communication device 10. Furthermore, the communication section 210 transmits an authentication request signal to the communication device 10 under control of the control section 220, and receives an authentication response signal from the communication device 10. The communication section 210 establishes communication connection with the communication device 10 by, for example, wireless communication. For example, NFC is used as a communication system of wireless communication in the present embodiment. However, other frequency bands or other wireless communication standards may be naturally used.

### Control Section 220

The control section 220 includes, for example, a Central Processing Unit (CPU) or a Micro Controller Unit (MCU), and, when a program stored in the storage section 230 is expanded on a Random Access Memory (RAM) and executed by the CPU, a function of the control section 220 can be realized. In this case, a computer readable recording medium having the program recorded therein can be also provided. Alternatively, the control section 220 may be configured as a dedicated hardware component, or may be configured as a combination of a plurality of hardware components.

The control section 220 controls all operations of the control device 20. For example, the control section 220 causes the communication section 210 to establish communication connection with the communication device 10. Furthermore, this control section 220 has functions of an identification information storage process section 221, a decision section 222, and an authentication process section 223, too.

The identification information storage process section 221 performs control of storing, in the storage section 230, identification information of a communication device whose authentication has succeeded.

The decision section 222 performs a process of deciding whether or not there is identification information that matches with identification information that is stored in advance in the storage section 230 and whose authentication has previously succeeded among each identification information obtained from the one or more communication devices 10.

The authentication process section 223 performs the authentication process on the communication device 10 according to a result of the decision made by the decision section 222. More specifically, the authentication process section 223 performs control of performing the authentication process on the communication device 10 that has been decided by the decision section 222 to match with the identification information whose authentication has previously succeeded. Consequently, even when a plurality of communication devices are authentication targets, it is possible to reduce a time taken until authentication of the communication devices succeeds.

The authentication process section 223 can perform the authentication process of authenticating the communication device 10 based on data transmitted and received to and from the authentication process target communication device 10 via the communication section 210. In this case, the authentication process section 223 can perform the authentication process by using the authentication key stored in advance in the storage section 230. A method of the authentication process that uses the authentication key is not limited in particular, yet includes, for example, a following example.

For example, the authentication process section 223 first generates a random number, and transmits the random number as an authentication request single from the communication section 210 to the communication device 10. Next, the communication device 10 encrypts the random number by the authentication key, and returns the random number as an authentication response signal to the control device 20. Furthermore, the authentication process section 223 of the control device 20 decrypts the random number by using the authentication key stored in the storage section 230, and decides whether the random number matches with the above generated random number. This authentication is also referred to as request response authentication. The control device 20 and the communication device 10 may perform mutual authentication of mutually performing this request response authentication on each other. Note that keys used for encryption and decryption may be different. Furthermore, authentication keys used for performing mutual authentication may be different.

The present embodiment has described as an example of authentication information that the authentication key including the algorithm for performing encryption and decryption is used. However, the present invention is not limited to this example. For example, the authentication information may be, for example, a predetermined password, a unique ID, a numerical value, a calculation formula, or a program.

When authentication by the authentication process section 223 succeeds, the control section 220 can control unlocking of the door lock of the vehicle 2. Alternatively, the control section 220 permits an operation of unlocking the door lock. Note that the operation that is permitted in a case where authentication succeeds is not limited to unlocking of the door lock, and may be, for example, turning on of a predetermined light provided to the vehicle 2, or may be starting of the engine. Control of various operations of the vehicle 2 may be performed by the control device 20, or may be performed by another device mounted on the vehicle 2.

### Storage Section 230

The storage section 230 is configured to store various pieces of information. For example, the storage section 230 stores, for example, programs and parameters used by the control section 220. Furthermore, the storage section 230 may store, for example, a process result of the control section 220 or information received by the communication section 210 from other devices. For example, the storage section 230 stores the authentication key that is an example of the authentication information. Note that contents of information stored in the storage section 230 is not limited in particular. Furthermore, the storage section 230 may be realized by, for example, a Rear Only Memory (ROM) or a RAM. Furthermore, as the storage section 230, a magnetic storage device such as a Hard Disk Drive (HDD), a semiconductor storage device, an optical storage device, or a magnetooptical storage device may be used.

The storage section 230 according to the present embodiment stores identification information of the successfully authenticated communication device 10 under control of the identification information storage process section 221.

A configuration example of the control device 20 according to the present embodiment has been described above. Note that the configuration of the control device 20 according to the present embodiment is not limited to the example illustrated in FIG. 1. For example, the control device 20 may include a plurality of devices. Furthermore, when communicating with the another device mounted on the vehicle 2, the control device 20 can transmit and receive data by using an in-vehicle communication network that conforms to arbitrary standards such as a Controller Area Network (CAN), a Local Interconnect Network (LIN), or a Local Area Network (LAN).

Furthermore, the functions of the control section 220 may be realized by, for example, an Electronic Control Unit (ECU) mounted on the vehicle 2, or a microcomputer mounted on the ECU. Furthermore, at least part of the functions of the control section 220 may be realized by an external device that is not mounted on the vehicle 2. The external device includes, for example, a cloud server on the Internet, a smartphone owned by a passenger, or a tablet terminal.

### 3. Operation

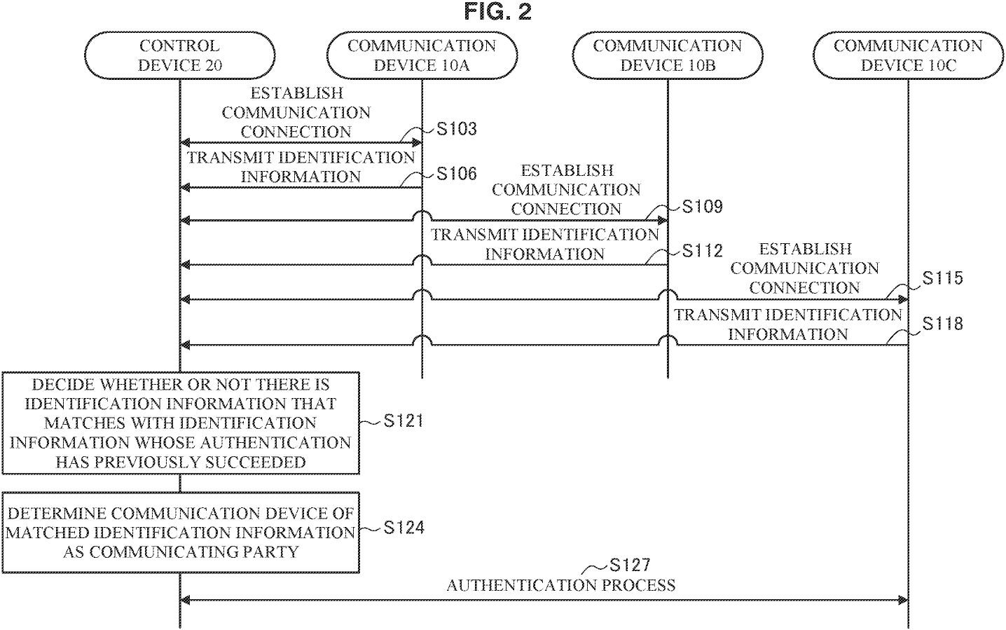

Next, an operation of the control system according to the present embodiment will be organized with reference to FIG. 2. FIG. 2 is a sequence diagram illustrating an operation example of the control system according to the embodiment. This operation example will describe a case as an example where the user places the communication device 10A to the communication device 10C close to the vehicle 2, and establishes communication connection with the control device 20 mounted on the vehicle 2 by NFC. The control device 20 establishes NFC communication with the communication device 10 that comes close within a range where NFC communication can be performed, request transmission of identification information to the communication device 10 with which communication connection has been established, and obtains the identification information. This operation example assumes a case where the communication device 10C that is the smartphone, the communication device 10A that is the transportation IC card housed in the smartphone case, and the communication device 10B that is the payment IC card housed in the smartphone case likewise are collectively placed close within the range where NFC communication can be performed.

As illustrated in FIG. 2, the control device 20 first establishes communication connection with the communication device 10A by NFC (step S103). When NFC communication with the control device 20 is established, the communication device 10A transmits identification information of the communication device 10A to the control device 20 in response to a request from the control device 20 (step S106).

Next, the control device 20 establishes communication connection with the communication device 10B by NFC (step S109). When NFC communication with the control device 20 is established, the communication device 10B transmits identification information of the communication device 10B to the control device 20 in response to a request from the control device 20 (step S112).

Next, the control device 20 establishes communication connection with the communication device 10C by NFC (step S115). When NFC communication with the control device 20 is established, the communication device 10C transmits identification information of the communication device 10C to the control device 20 in response to a request from the control device 20 (step S118).

Thus, the control device 20 obtains the identification information from each communication device 10 with which NFC communication has been established. Note that, although communication connection is established and the identification information is obtained in order of the communication device 10A, the communication device 10B, and the communication device 10C, this order is an example, and the present invention is not limited to this.

Subsequently, the decision section 222 of the control device 20 performs a process of deciding whether or not there is identification information that matches with identification information that is stored in advance in the storage section 230 and whose authentication has previously succeeded among the pieces of identification information of the communication device 10A to the communication device 10C obtained in above step S106, step S112, and step S118 (step S121). The storage section 230 stores the identification information of the communication devices 10 whose authentication has succeeded by an authentication process previously performed by the control device 20. This operation example will describe a case where the identification information of the communication device 10C including the authentication key K is stored in the storage section 230 as the identification information whose authentication has previously succeeded.

Next, when it is decided in above step S121 that there is the matched identification information, the control device 20 determines the communication device 10 having the matched identification information as a communicating party for performing the authentication process (step S124). In this operation example, the control device 20 decides that the identification information of the communication device 10 matches with the identification information that is stored in the storage section 230 and whose authentication has previously succeeded, and determines as the communicating party the communication device 10C for performing the authentication process.

Note that, when it is decided in above step S121 that there is no matched identification information, the control device 20 sequentially performs the authentication process on the communication device 10A to the communication device 10C. The order of the communication devices 10 on which the authentication process is performed in this case is the order of the pieces of identification information obtained by the control device 20.

Next, the authentication process section 223 of the control device 20 performs the authentication process on the communication device 10C that has been determined as the communicating party (step S 127). Although a specific procedure of the authentication process is not limited in particular, for example, the authentication process section 223 of the control device 20 may first generate the random number, and transmit the random number as the authentication request signal from the communication section 210 to the communication device 10C. Next, the communication device 10C encrypts the random number by the authentication key K, and returns the random number as the authentication response signal to the control device 20. Furthermore, the authentication process section 223 of the control device 20 can perform authentication by decrypting the random number by using the authentication key stored in the storage section 230, and deciding whether or not the random number matches with the above generated random number.

When authentication of the communication device 10C succeeds, the control device 20 performs control to unlock the door lock of the vehicle 2. Furthermore, the identification information storage process section 221 of the control device 20 stores, in the storage section 230, the identification information of the communication device 10C as identification information whose authentication has succeeded. The identification information whose authentication has succeeded may be overwritten and saved in the storage section 230, or may be accumulated together with authentication success dates as an authentication success history.

The operation example of the control system according to the present embodiment has been described above. As described above, when establishing communication connection with the plurality of communication devices 10, the control device 20 selects the communication device 10 that matches with the identification information of the communication device whose authentication has previously succeeded, and preferentially performs the authentication process. Consequently, even in a situation that the plurality of communication devices 10 can communicate with the control device 20, it is possible to reduce a time taken until authentication succeeds. Furthermore, the above-described operation example has described the case where NFC is used as communication means. However, the present invention is not limited to this.

### 4. Supplementary Explanation

Next, the control system according to the present embodiment will be supplementarily explained. The above-described embodiment has described that the decision section 222 of the control device 20 obtains the pieces of identification information from all of the communication device 10A to the communication device 10C with which communication connection can be established, and then performs a process of deciding whether or not there is identification information that matches with identification information whose authentication has previously succeeded (see above steps S103 to S121). However, the present invention is not limited to this example. For example, every time the decision section 222 of the control device 20 obtains the identification information from the one communication device 10 among the one or more communication devices 10, the decision section 222 may decide whether or not the identification information matches with identification information whose authentication has previously succeeded. For example, in the example illustrated in FIG. 2, when the identification information is obtained from the communication device 10A in step S106, the decision section 222 may decide whether or not the identification information of the communication device 10A matches with the identification information whose authentication has previously succeeded. When the identification information of the communication device 10A does not match, the authentication process section 223 then obtains the identification information from the communication device 10B (step S112), and decides whether or not the identification information of the communication device 10B matches. Thus, when, for example, matched identification information is found at an early stage by deciding whether or not the identification information matches every time the identification information is obtained from the one or more communication devices 10, it is possible to omit a decision process of deciding whether or not the identification information matches with those of the subsequent other communication devices 10, and further reduce the time.

Furthermore, the above-described embodiment has described the case as the example where there are the plurality of communication devices 10 as illustrated in FIGS. 1 and 2. However, the present invention is not limited to this example. For example, the number of the communication devices 10 may be one (singular). Similar to the operation example in the present embodiment, even in a case where the number of the communication devices 10 is one, the control device 20 obtains the identification information of the communication device 10, and decides whether or not the obtained identification information matches with the identification information that is stored in the storage section 230 and whose authentication has previously succeeded.

Furthermore, the above-described embodiment assumes that the storage section 230 of the control device 20 stores in advance only the identification information of the communication device 10C as the identification information whose authentication has previously succeeded. However, the present invention is not limited to this example. As the identification information whose authentication has previously succeeded, the storage section 230 of the control device 20 may store one identification information, or may store a plurality of pieces of identification information.

In a case where the plurality of pieces of identification information are stored in the storage section 230, the decision section 222 of the control device 20 may extract identification information whose number of times of past success of authentication is the largest among the pieces of identification information stored in the storage section 230, and decide whether or not there is identification information that matches with the extracted identification information among the obtained pieces of identification information of the one or more communication devices 10. The storage section 230 may store the identification information whose authentication has previously succeeded, and the number of times of success of authentication in association. When authentication of the communication device 10 succeeds, the identification information storage process section 221 performs a process of incrementing by 1 the number of times of success of authentication of the communication device 10 stored in the storage section 230. On the other hand, when authentication of the communication device 10 fails, the identification information storage process section 221 may delete the identification information of the communication device 10 from the storage section 230, or may update the number of times of success of authentication of the communication device 10 to 0.

Note that the present invention is not limited to the example where the number of times of success is stored in the storage section 230. The decision section 222 may calculate the number of times of authentication success of each identification information from a history of each identification information that is stored in the storage section 230 and whose authentication has previously succeeded. The storage section 230 may store identification information whose authentication has succeeded, and a history of success dates. Furthermore, when authentication of the communication device 10 succeeds, the identification information storage process section 221 performs a process of further storing, in the storage section 230, the history (the identification information and the authentication success dates) indicating that authentication of the communication device 10 has succeeded.

Furthermore, in a case where a plurality of pieces of identification information are stored in the storage section 230, the decision section 222 of the control device 20 may extract identification information whose authentication has lastly succeeded based on the success date of each identification information among pieces of identification information that are stored in the storage section 230 and whose authentication has previously succeeded. The decision section 222 decides whether or not there is identification information that matches with the extracted identification information (the identification information whose authentication has lastly succeeded) among the obtained one or more communication devices 10. Note that, when there is no matched identification information, the decision section 222 may extract identification information whose authentication has chronologically more previously succeeded, and decide whether or not the extracted identification information matches.

Furthermore, although the example described with reference to FIG. 2 assumes that authentication of the communication device 10C having the identification information that matches with the identification information whose authentication has previously succeeded succeeds, there may be assumed a case where the authentication fails due to some factors such as a case where there is a temporal restriction or a restriction of the number of times on the authentication key K. In this case, the identification information storage process section 221 of the control device 20 may delete the identification information of the communication device 10C from the storage section 230. Furthermore, the authentication process section 223 of the control device 20 sequentially performs the authentication process on the communication devices 10 (the communication device 10A and the communication device 10B in the example illustrated in FIG. 2) other than the communication device 10C.

### 5. Conclusion

The preferred embodiment of the present invention has been described in detail above with reference to the accompanying drawings. However, the present invention is not limited to this example. It should be understood by those who have common knowledge in the technical field to which the present invention belongs that it is obvious that various change examples or alteration examples can be arrived at within the scope of the technical idea recited in the claims, and these change examples and alteration examples also naturally belong to the technical scope of the present invention.

For example, the vehicle is used above as an example of the movable body that is mounted on the control device 20. However, the movable body according to the present embodiment is not limited to the vehicle, and may be ships (such as passenger ships, cargo ships, or submarines) and aircrafts (such as airplanes, helicopters, gliders, or airships). Furthermore, the vehicle is not limited to cars, and may be buses, motorcycles, locomotives, or trains. Furthermore, the movable body is not necessarily limited to the above example, and may be a movable object. Furthermore, the control device 20 mounted on the movable body is merely an example, and the control device 20 may be mounted on other than the movable body, and perform the above-described control.

Furthermore, the above-described contents of the embodiment and supplementarily explained contents may be each combined.

Furthermore, the effect disclosed in this description is only explanatory or exemplary, and is not restrictive. That is, together with the above effect or instead of the above effect, the technology according to the present disclosure exhibits other effects that are obvious for those who have common knowledge in the technical field from the disclosure of this description.

Furthermore, all of each step related to the process of the control device in this description does not necessarily need to be processed in time series in the order described in the sequence diagram.

Furthermore, it is possible to create one or more programs that cause hardware such as a CPU, a ROM, and a RAM built in a computer to exhibit functions equivalent to those of the components included in the communication devices 10 or the control device 20, and provide a computer readable recording medium, too, having the one or more programs recorded therein.

What is claimed is:

1. A control device comprising a control section configured to perform
a process of deciding whether or not there is identification information that is stored in advance and matches with identification information whose authentication has previously succeeded among each identification information obtained from one or more communication devices, and
a process of controlling execution of an authentication process of authenticating a communication device, according to a decision result.

2. The control device according to claim 1,
wherein the control section executes the authentication process with respect to a communication device of the matched identification information.

3. The control device according to claim 1,
wherein the control section performs a process of storing, in a storage section, identification information of a communication device whose authentication has succeeded.

4. The control device according to claim 3,
wherein the control section executes the authentication process with respect to a communication device that matches with identification information whose number of times of success of authentication is the largest.

5. The control device according to claim 3,
wherein the control section executes the authentication process with respect to a communication device of identification information that matches with identification information indicating a communication device that has lastly succeeded in being authenticated.

6. The control device according to claim 3,
wherein, when failing in authenticating the communication device of the matched identification information, the control section deletes the identification information of the communication device from the storage section.

7. The control device according to claim 1,
wherein, in a case where there is no matched identification information, the control section sequentially executes the authentication process with respect to each of the communication devices.

8. The control device according to claim 1,
wherein, after obtaining all pieces of identification information of a plurality of communication devices, the control section decides whether or not there is identification information that matches with identification information whose authentication has previously succeeded.

9. The control device according to claim 1,
wherein the control section decides in order whether or not one previously obtained identification information matches with the identification information whose authentication has previously succeeded among a plurality of communication devices, and executes the authentication process with respect to a corresponding communication device when there is matched identification information.

10. The control device according to claim 1,
wherein the control device further comprises a communication section configured to perform wireless communication.

11. The control device according to claim 10,
wherein the communication section uses near field wireless communication that is wireless communication of a short communication distance as the wireless communication.

12. The control device according to claim 11,
wherein the near field wireless communication is communication that uses Near Field Communication (NFC).

13. The control device according to claim 1,
wherein the one or more communication devices include at least one of a smartphone and an Integrated Circuit (IC) card.

14. The control device according to claim 1,
wherein the control device is a device that is mounted on a movable body.

15. A control method comprising at a processor:
deciding whether or not there is identification information that is stored in advance and matches with identification information whose authentication has previously succeeded among each identification information obtained from one or more communication devices; and
controlling execution of an authentication process of authenticating a communication device, according to a decision result.
